(19) United States
(12) Patent Application Publication
(10) Pub. No.: US 2025/0358029 A1
(43) Pub. Date: Nov. 20, 2025

(54) TEST SYSTEM AND TRANSMISSION ANTENNA CORRELATION ESTIMATION METHOD

(71) Applicant: ANRITSU CORPORATION, Kanagawa (JP)

(72) Inventors: Takeshi KOBAYASHI, Kanagawa (JP); Keisuke TAKIZAWA, Kanagawa (JP); Hirofumi SUGANUMA, Kanagawa (JP)

(21) Appl. No.: 19/199,944

(22) Filed: May 6, 2025

(30) Foreign Application Priority Data
May 14, 2024 (JP) 2024-078908

(51) Int. Cl. H04B 17/391; H04B 17/309

(52) U.S. Cl. CPC H04B 17/3912; H04B 17/309

(57) ABSTRACT

A test system includes an actual propagation path estimation characteristic calculation unit that calculates estimation characteristics of propagation path characteristics of an actual propagation path, an actual propagation path channel capacity calculation unit that calculates an actual propagation path channel capacity of the actual propagation path from the estimation characteristics, a simulation propagation path characteristic calculation unit that calculates simulation propagation path characteristics of a channel model, a simulation channel capacity calculation unit that calculates a simulation channel capacity of the channel model from the simulation propagation path characteristics, a transmission antenna correlation coefficient estimation unit that estimates a transmission antenna correlation coefficient in which a difference between the actual propagation path channel capacity and the simulation channel capacity is smaller than a specified value, and a transmission antenna correlation calculation unit that calculates a transmission antenna correlation based on the transmission antenna correlation coefficient.

### TECHNICAL FIELD

The present invention relates to a test system using a channel model and a transmission antenna correlation estimation method.

### BACKGROUND ART

In a case of testing a mobile phone terminal (user equipment: UE), a signal obtained by passing a downlink signal output from a base station simulator through a propagation path simulator is supplied to a mobile radio terminal, to evaluate demodulation performance in a fading environment. As a channel model used in the propagation path simulator, a channel model defined in a test standard is often used. Meanwhile, there is also a demand for evaluating the demodulation performance of the UE using a channel model having propagation path characteristics close to an actual propagation path environment.

In general, as a method for simulating the actual propagation path environment, a method for replaying the propagation path characteristics measured in the actual propagation path environment is known.

In the “Field-to-Lab” (for example, see Non-Patent Document 1) of the ACE RNX Channel Emulator, data of a downlink signal transmitted by an actual base station that travels through an actual propagation path is collected, and the data is analyzed to extract the propagation path characteristics of the actual propagation path, and an instantaneous value of the propagation path characteristics of the actual propagation path is replayed as it is to perform a test on a demodulation unit of the UE. By replaying the actual propagation path characteristics as they are, “Field-to-Lab” can faithfully replay the actual propagation path characteristics.

However, since the existing “Field-to-Lab” disclosed in Non-Patent Document 1 replays the actual propagation path characteristics without change, the test time of the UE is determined depending on the data collection time. Since antennas at the time of data collection are different from actual antennas of the UE, there is no significant meaning in replaying the instantaneous value of the propagation path characteristics itself.

Therefore, as illustrated in FIG. 8, it is considered that a downlink signal transmitted from an actual base station 100 to a UE 10a (or an air monitor 10b) is collected using the air monitor 10b or the like, a reference signal (RS) included in the collected signal is analyzed to calculate parameters of a channel model in a multiple input multiple output (MIMO) propagation path simulator of a test environment, and a test using a fading model close to an actual environment is performed.

### RELATED ART DOCUMENT

### Non-Patent Document

[Non-Patent Document 1] “ACE RNX Channel Emulator” Product Catalog, Mar. 1, 2018

### DISCLOSURE OF THE INVENTION

### Problem that the Invention is to Solve

There is a transmission antenna correlation as one of the parameters of the channel model, but in a case where the parameters of the channel model are calculated using a demodulation reference signal (DMRS) of a channel subjected to precoding in a transmission unit of the base station, such as a PDSCH, which is mainly a data channel, it is difficult to directly calculate the transmission antenna correlation for the following reasons.

For example, in a case where the base station 100 transmits the PDSCH as the downlink signal in Transmission mode={8, 9} for a fourth-generation mobile phone system (LTE-Advanced) or a fifth-generation mobile phone system (5G NR), the DMRS is transmitted together with user data as illustrated in FIG. 8. In this case, the user data and the DMRS are subjected to common precoding for each layer by a precoder 130. That is, since the precoding is integrated with the propagation path characteristics, it is not possible to distinguish between the propagation path characteristics and the precoding from the signal received by the air monitor 10b or the like.

For example, as illustrated in FIG. 8, a different precoding matrix may be applied for each sub-band on a frequency axis or for each symbol on a time axis. Since a relative phase among the transmission antennas of the base station 100 depends on the precoding matrix, in a case where the transmission antenna correlation is directly calculated as defined, it has been impossible in the related art to accurately estimate the transmission antenna correlation of the propagation path by eliminating a phase deviation caused by the precoding matrix different for each sub-band or each symbol.

The influence of the precoding on the transmission antenna correlation can be described as below.

As indicated by Expression (1), the transmission antenna correlation is defined as a transmission antenna correlation matrix indicating correlations among the propagation path characteristics from a plurality of transmission antennas Tx#1 to Tx#4 to one reception antenna Rx#y. FIG. 9 illustrates propagation path characteristics in a case where the number of transmission antennas Tx is four.

$$\begin{matrix}( Transmission antenna \\ correlation matrix )\end{matrix} = \frac{1}{N K} {\sum }_{n = 1}^{N} {\sum }_{k = 1}^{K} \{ [ \begin{matrix}{h}_{y 1}^{( k , n )} \\ {h}_{y 2}^{( k , n )} \\ {h}_{y 3}^{( k , n )} \\ {h}_{y 4}^{( k , n )}\end{matrix} ] {[ \begin{matrix}{h}_{y 1}^{( k , n )} \\ {h}_{y 2}^{( k , n )} \\ {h}_{y 3}^{( k , n )} \\ {h}_{y 4}^{( k , n )}\end{matrix} ]}^{H} \} \qquad ( 1 )$$

$$Vector [ \begin{matrix}{h}_{y 1}^{( k , n )} \\ {h}_{y 2}^{( k , n )} \\ {h}_{y 3}^{( k , n )} \\ {h}_{y 4}^{( k , n )}\end{matrix} ] is propagation path characteristics from transmission antennas Tx \text{?} to Tx \text{?} to one reception antenna \text{?} .$$

$${[ \begin{matrix}{h}_{y 1}^{( k , n )} \\ {h}_{y 2}^{( k , n )} \\ {h}_{y 3}^{( k , n )} \\ {h}_{y 4}^{( k , n )}\end{matrix} ]}^{H} is vector [ \begin{matrix}{h}_{y 1}^{( k , n )} \\ {h}_{y 2}^{( k , n )} \\ {h}_{y 3}^{( k , n )} \\ {h}_{y 4}^{( k , n )}\end{matrix} ] \text{?} s conjugate transpose .$$

$$\text{?} \text{indicates text missing or illegible when filed}$$

In Expression (1), k is an index in a frequency axis direction, and is, for example, an index of a subcarrier number. Further, n is an index in a time axis direction, and is, for example, an index of an orthogonal frequency division multiplexing (OFDM) symbol number. Here, k is an integer from 1 to K, and n is an integer from 1 to N. In addition, it is assumed that an average power of propagation path characteristics h_{yx}^{(k,n)} is normalized to 1.

The values for k and n of the x₁ row and x₂ column component in the transmission antenna correlation matrix are calculated as the correlation coefficients between h_{yx1}^{(k,n)} and h_{yx2}^{(k,n)}. The correlation coefficient depends on a relative phase between h_{yx1}^{(k,n)} and h_{yx2}^{(k,n)}, as indicated by Expression (2).

$$\begin{matrix}( Relative phase ) = ∠ {h}_{y {x}_{1}}^{( k , n )} − ∠ {h}_{y {x}_{2}}^{( k , n )} \\ = ∠ {h}_{y {x}_{1} ( p r c )}^{( k , n )} + ∠ {h}_{y {x}_{1} ( c h )}^{( k , n )} − ∠ {h}_{y {x}_{2} ( p r c )}^{( k , n )} − ∠ {h}_{y {x}_{2} ( c h )}^{( k , n )}\end{matrix} \qquad ( 2 )$$

Here, the relative phase of Expression (2) includes phases ∠h\hat{ }_{y1x(prc)}^{(k,n)} and ∠h\hat{ }_{y2x(prc)}^{(k,n)} due to the precoding, and phases ∠h\hat{ }_{y1x(ch)}^{(k,n)} and ∠h\hat{ }_{y1x(ch)}^{(k,n)} due to the MIMO propagation path.

Therefore, the x₁ row and x₂ column component in the transmission antenna correlation matrix is represented as in Expression (3).

$$( {x}_{1} , {x}_{2} ) = \frac{1}{N K} {\sum }_{n = 1}^{N} {\sum }_{k = 1}^{K} \{ {h}_{y {x}_{1}}^{( k , n )} {h}_{y {x}_{2}}^{( k , n )} \text{?} \} = \frac{1}{N K} {\sum }_{n \geq 1}^{N} {\sum }_{k = 1}^{K} \{ \vert {h}_{y {x}_{1}}^{( k , n )} \vert \vert {h}_{y {x}_{2}}^{( k , n )} \vert e {\text{?}}^{( ∠ {h}_{y {x}_{2}}^{( k , n )} − ∠ {h}_{y {x}_{2}}^{( k , n )} )} \} = \frac{1}{N K} {\sum }_{n = 1}^{N} {\sum }_{k = 1}^{N} \{ \vert {h}_{y {x}_{1}}^{( k , n )} \vert \vert {h}_{y {x}_{2}}^{( k , n )} \vert {e}^{j ( ∠ {h}_{y {x}_{1} ( prc )}^{( k , n )} + ∠ {h}_{y {x}_{1}}^{( k , n )} \text{?} ∠ {h}_{y {x}_{2} ( prc )}^{( k , {x}_{2} )} ⋯ ∠ {h}_{y {x}_{2}}^{( k , n )} \text{?} )} \} \qquad ( 3 )$$

$$\text{?} \text{indicates text missing or illegible when filed}$$

As illustrated in FIG. 8, since the phases ∠h\hat{ }_{y1x(prc)}^{(k,n)} and ∠h\hat{ }_{y2x(prc)}^{(k,n)} due to the precoding can have different values depending on the subcarrier number k and the OFDM symbol number n, it can be seen from Expression (3) that the transmission antenna correlation of the MIMO propagation path itself cannot be directly calculated.

The present invention has been made to solve the above-described problems in the related art, and an object of the present invention is to provide a test system and a transmission antenna correlation estimation method capable of accurately calculating a transmission antenna correlation by analyzing a reference signal such as a DMRS subjected to precoding.

### Means for Solving the Problem

In order to achieve the above-described object, an aspect of the present invention relates to a test system including: an actual propagation path estimation characteristic calculation unit (21) that calculates estimation characteristics of propagation path characteristics of an actual propagation path (110) by using a reference signal included in IQ data of downlink signals output from an antenna device (10) that receives the downlink signals transmitted from a plurality of transmission antennas (Tx#1 to Tx#N_{TxAnt}) of a network-side transmission/reception device (100) by one or more reception antennas (Rx#1 to Rx#N_{RxAnt}) in an environment of the actual propagation path; an actual propagation path channel capacity calculation unit (29) that calculates an actual propagation path channel capacity of the actual propagation path from the estimation characteristics; a K factor calculation unit (24) that calculates a K factor from the estimation characteristics; a reception antenna correlation calculation unit (26) that calculates a reception antenna correlation that is a correlation among the estimation characteristics from each transmission antenna to the one or more reception antennas; a transmission antenna correlation calculation unit (25) that calculates a transmission antenna correlation that is a correlation among the estimation characteristics from the plurality of transmission antennas to each reception antenna by a transmission antenna correlation matrix that includes a transmission antenna correlation coefficient as a parameter; a simulation propagation path characteristic calculation unit (32) that calculates simulation propagation path characteristics of a channel model based on the K factor, the transmission antenna correlation, and the reception antenna correlation; a simulation channel capacity calculation unit (30) that calculates a simulation channel capacity of the channel model from the simulation propagation path characteristics; and a transmission antenna correlation coefficient estimation unit (27) that estimates the transmission antenna correlation coefficient in which a difference between the actual propagation path channel capacity and the simulation channel capacity is smaller than a specified value, in which the transmission antenna correlation calculation unit calculates the transmission antenna correlation by substituting the transmission antenna correlation coefficient estimated by the transmission antenna correlation coefficient estimation unit into the transmission antenna correlation matrix.

With this configuration, in the test system according to the aspect of the present invention, the transmission antenna correlation is calculated such that the actual propagation path channel capacity calculated based on the RS included in the IQ data of the downlink signals propagated from an actual base station to the antenna device and the simulation channel capacity by the channel model are equivalent to each other.

Accordingly, in the test system according to the aspect of the present invention, the RS such as a DMRS subjected to precoding can be analyzed, to accurately estimate the transmission antenna correlation.

In the test system according to the aspect of the present invention, a throughput test of a device under test can be performed with a channel model that can obtain a throughput equivalent to that of an actual MIMO propagation path.

In addition, the test system according to the aspect of the present invention can perform a test on a device under test in a form in which the statistical propagation path characteristics of the actual propagation path are reproduced by using the simulation propagation path characteristics.

The test system according to the aspect of the present invention may further include: a relative phase estimation unit (28) that calculates estimation values of relative phases of lines of sight of the downlink signals from the plurality of transmission antennas to the reception antennas, in which the simulation propagation path characteristic calculation unit calculates the simulation propagation path characteristics sum of a line-of-sight component including the estimation values of the relative phases of the lines of sight and a non-line-of-sight component not including the influence of the line-of-sight component.

With this configuration, the test system according to the aspect of the present invention can calculate the simulation channel capacity that reflects a phase relationship in the line-of-sight component, similarly to a phase relationship in the actual IQ data.

In the test system according to the aspect of the present invention, the reception antenna correlation calculation unit may calculate the reception antenna correlation such that an influence of the line-of-sight component is excluded taking account of the estimation values of the relative phases of the line-of-sight component.

Another aspect of the present invention relates to a transmission antenna correlation estimation method including: an actual propagation path estimation characteristic calculation step (S22) of calculating estimation characteristics of propagation path characteristics of an actual propagation path (110) by using a reference signal included in IQ data of downlink signals output from an antenna device (10) that receives the downlink signals transmitted from a plurality of transmission antennas (Tx#1 to Tx#NTxAnt) of a network-side transmission/reception device (100) by one or more reception antennas (Rx#1 to Rx#NRxAnt) in an environment of the actual propagation path; an actual propagation path channel capacity calculation step (S23) of calculating an actual propagation path channel capacity of the actual propagation path the estimation characteristics; a K factor calculation step (S24) of calculating a K factor from the estimation characteristics; a reception antenna correlation calculation step (S26) of calculating a reception antenna correlation that is a correlation among the estimation characteristics from each transmission antenna to the one or more reception antennas; a transmission antenna correlation calculation step (S28) of calculating a transmission antenna correlation that is a correlation among the estimation characteristics from the plurality of transmission antennas to each reception antenna by a transmission antenna correlation matrix that includes a transmission antenna correlation coefficient as a parameter; a simulation propagation path characteristic calculation step (S3, S6, S13) of calculating simulation propagation path characteristics of a channel model based on the K factor, the transmission antenna correlation, and the reception antenna correlation; a simulation channel capacity calculation step (S3, S6, S13) of calculating a simulation channel capacity of the channel model from the simulation propagation path characteristics; and a transmission antenna correlation coefficient estimation step (S27) of estimating the transmission antenna correlation coefficient in which a difference between the actual propagation path channel capacity and the simulation channel capacity is smaller than a specified value, in which, in the transmission antenna correlation calculation step, the transmission antenna correlation is calculated by substituting the transmission antenna correlation coefficient estimated by the transmission antenna correlation coefficient estimation step into the transmission antenna correlation matrix.

The transmission antenna correlation estimation method according to the aspect of the present invention may further include: a relative phase estimation step (S25) of calculating estimation values of relative phases of lines of sight of the downlink signals from the plurality of transmission antennas to the reception antennas, in which, in the simulation propagation path characteristic calculation step, the simulation propagation path characteristics consisting of a sum of a line-of-sight component including the estimation values of the relative phases of the lines of sight and a non-line-of-sight component not including the influence of the line-of-sight component.

In the transmission antenna correlation estimation method according to the aspect of the present invention, in the reception antenna correlation calculation step, the reception antenna correlation may be calculated such that an influence of the line-of-sight component is excluded taking account of the estimation values of the relative phases of the line-of-sight component.

### Advantage of the Invention

The present invention provides a test system and a transmission antenna correlation estimation method capable of accurately calculating a transmission antenna correlation by analyzing a reference signal such as a DMRS subjected to precoding.

### BRIEF DESCRIPTION OF THE DRAWINGS

FIG. 1 is a diagram schematically illustrating an environment of an actual propagation path between a base station and an antenna device.

FIG. 2 is a block diagram illustrating a configuration of a test system according to an embodiment of the present invention.

FIG. 3 is a diagram illustrating a definition of a reception antenna correlation matrix.

FIG. 4 is a graph illustrating processing performed by a transmission antenna correlation coefficient estimation unit.

FIG. 5A is a graph illustrating processing of the transmission antenna correlation coefficient estimation unit in a case where a simulation channel capacity is greater than an actual propagation path channel capacity, and FIG. 5B is a graph illustrating processing of the transmission antenna correlation coefficient estimation unit in a case where the simulation channel capacity is smaller than the actual propagation path channel capacity.

FIG. 6 is a flowchart illustrating an example of specific processing of the transmission antenna correlation coefficient estimation unit, a simulation channel capacity calculation unit, and a simulation propagation path characteristic calculation unit.

FIG. 7 is a flowchart illustrating processing of a transmission antenna correlation estimation method using the test system according to the embodiment of the present invention.

FIG. 8 is a diagram illustrating precoding applied to a transmission unit of a base station.

FIG. 9 is a diagram illustrating a definition of a transmission antenna correlation matrix.

### AN EXAMPLE FOR CARRYING OUT THE INVENTION

Hereinafter, embodiments of a test system and a transmission antenna correlation estimation method according to the present invention will be described with reference to the accompanying drawings.

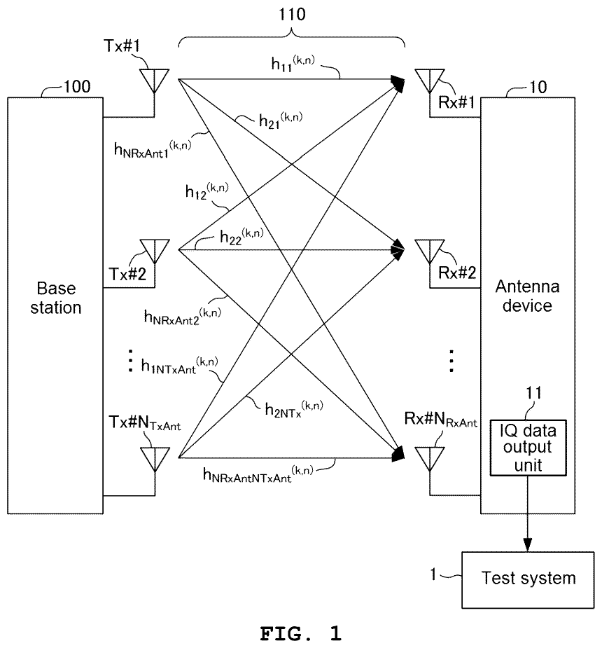

FIG. 1 is a diagram schematically illustrating an environment of an actual propagation path 110, which is a MIMO propagation path, between a base station 100 as an example of a network-side transmission/reception device and an antenna device 10. In FIG. 1, data communication between the base station 100 and the antenna device 10 is performed using a plurality of subcarriers in accordance with the OFDM modulation method.

The antenna device 10 receives downlink signals transmitted from N_{TxAnt} transmission antennas Tx#1 to Tx#N_{TxAnt} of the base station 100 in an environment of the actual propagation path 110 including a plurality of channels. For example, the antenna device 10 is an air monitor, a UE, or the like. The antenna device 10 includes N_{RxAnt} reception antennas Rx#1 to Rx#N_{RxAnt} that receive the downlink signals transmitted from the transmission antennas Tx#1 to Tx#N_{TxAnt} of the base station 100 as reception signals, and an IQ data output unit 11.

Here, the number N_{TxAnt} of the transmission antennas Tx#1 to Tx#N_{TxAnt} Of the base station 100 and the number N_{RxAnt} of the reception antennas Rx#1 to Rx#N_{RxAnt} of the antenna device 10 are each an integer of 2 or more and 1 or more, and a value of N_{TxAnt}×N_{RxAnt} is the number of channels of the actual propagation path 110.

The IQ data output unit 11 performs reception processing such as amplification, frequency conversion, and analog-to-digital conversion on N_{RxAnt} reception signals received by the reception antennas Rx#1 to Rx#N_{RxAnt}. Further, the IQ data output unit 11 demodulates the N_{RxAnt} reception signals subjected to the reception processing to generate N_{RxAnt} sets of I component baseband signals and Q component baseband signals that are orthogonal to each other. In the present specification, the I component baseband signals and the Q component baseband signals are collectively referred to as “IQ data”.

In FIG. 1, h₁₁^{(k,n)}, h₂₁^{(k,n)}, . . . , h_{NRxAnt1}^{(k,n)}, h₁₂^{(k,n)}, h₂₂^{(k,n)}, . . . , h_{NRxAnt2}^{(k,n)}, . . . , h_{1NTxAnt}^{(k,n)}, h_{2NTxAnt}^{(k,n)}, . . . , and h_{NRxAntNTxAnt}^{(k,n)} are elements of an actual propagation path matrix H(k,n) in a frequency domain of N_{TxAnt}×N_{RxAnt} MIMO illustrated in Expression (4) which will be described later.

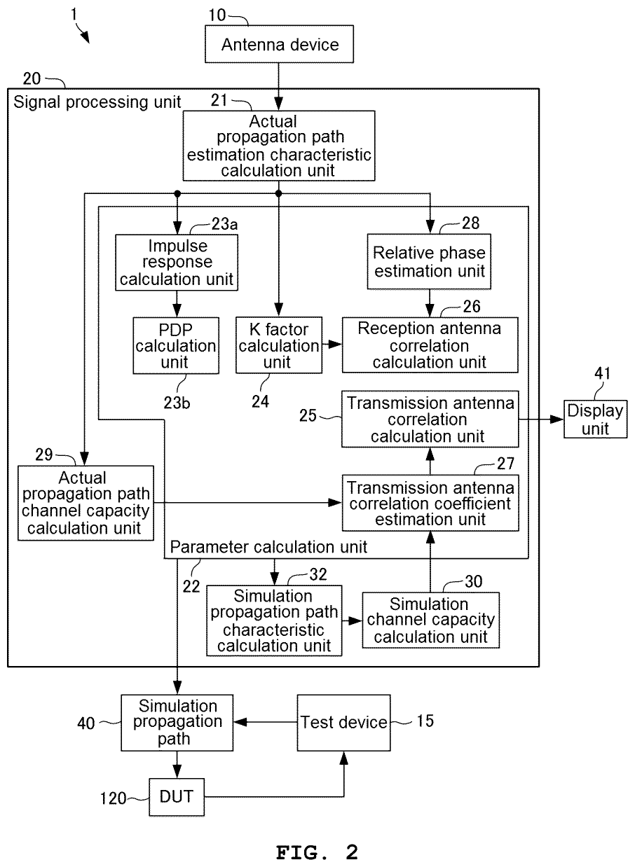

As illustrated in FIG. 2, the test system 1 according to the present embodiment includes a test device 15, a signal processing unit 20, a simulation propagation path 40, and a display unit 41.

The test device 15 includes a function of a base station simulator that generates a downlink signal required to test a device under test (DUT) 120, transmits the downlink signal to the DUT 120 via a simulation propagation path 40, receives an uplink signal transmitted from the DUT 120, and performs processing required for the test. The test device 15 performs, for example, a test of the demodulation performance of the DUT 120. The simulation propagation path 40 between the test device 15 and the DUT 120 is formed by parameters calculated by a parameter calculation unit 22 which will be described later. The DUT 120 is a UE capable of performing communication at least in a MIMO method or a multiple input single output (MISO) method.

The signal processing unit 20 includes an actual propagation path estimation characteristic calculation unit 21, a parameter calculation unit 22, an actual propagation path channel capacity calculation unit 29, a simulation channel capacity calculation unit 30, and a simulation propagation path characteristic calculation unit 32.

The signal processing unit 20 is, for example, configured by a control device such as a computer including a central processing unit (CPU), a graphics processing unit (GPU), a field programmable gate array (FPGA), a read only memory (ROM), a random access memory (RAM), a hard disk drive (HDD), and the like. The signal processing unit 20 can configure at least a part of the actual propagation path estimation characteristic calculation unit 21, the parameter calculation unit 22, the actual propagation path channel capacity calculation unit 29, the simulation channel capacity calculation unit 30, and simulation propagation path characteristic calculation unit 32 in a software manner by executing a predetermined program by the CPU or the GPU.

The above-described program is stored in the ROM or the HDD in advance. Alternatively, the program may be provided or distributed in a state of being recorded on a computer-readable recording medium such as a compact disc or a DVD in an installable or executable form. Alternatively, the above-described program may be stored in a computer connected to a network such as the Internet, and provided or distributed by downloading the program via the network.

The display unit 41 is configured by, for example, a display device such as a liquid crystal display (LCD) or a cathode ray tube (CRT), and displays a setting screen for performing settings related to a test content of the test system 1, a test result, a calculation result of a transmission antenna correlation, and the like based on a display control signal from the signal processing unit 20. The display unit 41 may have an operation function such as a soft key on a display screen.

The actual propagation path estimation characteristic calculation unit 21 calculates estimation characteristics h\hat{ }_{yx}^{(k,n)} of propagation path characteristics h_{yx}^{(k,n)} in a frequency domain of the plurality of channels constituting the actual propagation path 110, by using the RS included in the IQ data output from the IQ data output unit 11 of the antenna device 10.

Here, h_{yx}^{(k,n)} represents each element of the actual propagation path matrix H(k,n) of the actual propagation path 110 in Expression (4). Here, y is an index of N_{RxAnt} reception antennas Rx#1 to Rx#N_{RxAnt} of the antenna device 10, and is an integer from 1 to N_{RxAnt}. Here, x is an index of N_{TxAnt} transmission antennas Tx#1 to Tx#N_{TxAnt} of the base station 100, and is an integer from 1 to N_{TxAnt}.

That is, N_{RxAnt}=1 and N_{TxAnt}≥2 represent the MISO method, and N_{RxAnt}≥2 and N_{TxAnt}≥2 represent the MIMO method.

$$H ( k , n ) = [ {h}_{y x}^{( k , n )} ] = [ \begin{matrix}{h}_{11}^{( k , n )} & {h}_{12}^{( k , n )} & … & {h}_{1 {N}_{T \times Ant}}^{( k , n )} \\ {h}_{21}^{( k , n )} & {h}_{22}^{( k , n )} & … & {h}_{2 {N}_{T \times Ant}}^{( k , n )} \\ ⋮ & ⋮ & ⋱ & ⋮ \\ {h}_{{N}_{R \times {Ant}^{1}}}^{( k , n )} & {h}_{{N}_{R \times {Ant}^{2}}}^{( k , n )} & ⋯ & {h}_{{N}_{R \times Ant} {N}_{T \times Ant}}^{( k , n )}\end{matrix} ] \qquad ( 4 )$$

In Expression (4), k is an index in a frequency axis direction, and is, for example, an index of a subcarrier number. Here, in a case where Δf is a frequency spacing of the subcarrier, a frequency fₖ of each subcarrier is k×Δf. In addition, n is an index in a time axis direction, and is, for example, an index of an OFDM symbol number. Here, k is an integer from 1 to K, and n is an integer from 1 to N. In addition, it is assumed that an average power of propagation path characteristics h_{yx}^{(k,n)} is normalized to 1.

The RS included in the IQ data output from the IQ data output unit 11 of the antenna device 10 is, for example, a channel state information reference signal (CSI-RS), a demodulation reference signal (DMRS), a tracking reference signal (TRS), a phase tracking reference signal (PTRS), and the like in the 5G NR standard.

The actual propagation path estimation characteristic calculation unit 21 calculates the estimation characteristics h\hat{ }_{yx}^{(k,n)} of the propagation path characteristics h_{yx}^{(k,n)} from a known RS included in the downlink signals transmitted from N_{TxAnt} transmission antennas Tx#1 to Tx#_{NTxAnt} of the base station 100 and an RS of each channel included in N_{RxAnt} sets of IQ data output from the IQ data output unit 11. The estimation characteristics h\hat{ }_{yx}^{(k,n)} include information on an amplitude fluctuation amount and a phase fluctuation amount of the RS of the IQ data obtained from the reception signal received by a y-th reception antenna Rx#y from the known RS transmitted by an x-th transmission antenna Tx#x.

For example, in the case of the 5G NR standard, the actual propagation path estimation characteristic calculation unit 21 uses the RS signals such as the CSI-RS, the DMRS, the TRS, and the PTRS included in the IQ data and the corresponding known RS signal patterns, for the calculation of the estimation characteristics h\hat{ }_{yx}^{(k,n)}. Here, h\hat{ }_{yx}^{(k,n)} represents each element of a matrix H\hat{ }_{yx}^{(k,n)}, which is the estimation matrix of the actual propagation path matrix H(k,n) of the actual propagation path 110 in Expression (4), and is represented as in Expression (5).

$$\hat{H} ( k , n ) = [ {h}_{y x}^{( k , n )} ] = [ \begin{matrix}{\hat{h}}_{11}^{( k , n )} & {\hat{h}}_{12}^{( k , n )} & … & {\hat{h}}_{1 {N}_{T \times Ant}}^{( k , n )} \\ {\hat{h}}_{21}^{( k , n )} & {\hat{h}}_{22}^{( k , n )} & … & {\hat{h}}_{2 {N}_{T \times Ant}}^{( k \times n )} \\ ⋮ & ⋮ & ⋱ & ⋮ \\ {\hat{h}}_{{N}_{R \times {Ant}^{1}}}^{( k , n )} & {\hat{h}}_{{N}_{R \times {Ant}^{2}}}^{( k , n )} & ⋯ & {\hat{h}}_{{N}_{R \times Ant} {N}_{T \times Ant}}^{( k , n )}\end{matrix} ] \qquad ( 5 )$$

The parameter calculation unit 22 calculates channel model parameters characterizing the statistical properties of the estimation characteristics h\hat{ }_{yx}^{(k,n)} calculated by the actual propagation path estimation characteristic calculation unit 21. That is, the parameter calculation unit 22 calculates the parameters by using the estimation characteristics h\hat{ }_{yx}^{(k,n)} within a period in which the statistical properties are not changed among the estimation characteristics h\hat{ }_{yx}^{(k,n)} calculated by the actual propagation path estimation characteristic calculation unit 21. The parameters calculated by the parameter calculation unit 22 are input to the simulation propagation path characteristic calculation unit 32 and the simulation propagation path 40.

The simulation propagation path characteristic calculation unit 32 and the simulation propagation path 40 include, for example, a known channel model such as a tapped delay line (TDL) model, a clustered delay line (CDL) model, and the like. The simulation propagation path characteristic calculation unit 32 calculates frequency characteristics to be generated at the simulation propagation path 40 in accordance with the parameters of the channel model calculated by the parameter calculation unit 22.

For example, the parameter calculation unit 22 includes an impulse response calculation unit 23a, a power delay profile (PDP) calculation unit 23b, a K factor calculation unit 24, a transmission antenna correlation calculation unit 25, a reception antenna correlation calculation unit 26, a transmission antenna correlation coefficient estimation unit 27, and a relative phase estimation unit 28, and calculates parameters such as a “PDP”, a “K factor”, a “transmission antenna correlation matrix”, and a “reception antenna correlation matrix”.

Further, the simulation propagation path 40 functions as a propagation path simulator formed between the test device 15 and the DUT 120 based on the parameters of the channel model calculated by the parameter calculation unit 22.

Hereinafter, an example of a method of calculating the “PDP”, the “K factor”, “transmission antenna correlation matrix”, and the “reception antenna correlation matrix” by the parameter calculation unit 22 will be described using the TDL model as an example.

The estimation characteristics h\hat{ }_{yx}^{(k,n)} are frequency characteristics having k as the index in the frequency axis direction, and can be represented by an impulse response consisting of a plurality of delay taps τₘₜ corresponding to a plurality of paths.

The impulse response calculation unit 23a calculates an impulse response g_{yx}^{(mt,n)} of Expression (6) from the estimation characteristics h\hat{ }_{yx}^{(k,n)} in Expression (5). Here, a generalized inverse matrix of the matrix A is represented by A+. Mt represents the number of delay taps, and mt is an integer from 1 to Mt. The matrix A is a kind of Fourier transform matrix that can calculate a column vector having elements of the frequency characteristics by multiplying a column vector having elements of the impulse response in the time domain.

$$[ \begin{matrix}{g}_{yx}^{( 1 , n )} \\ {g}_{yx}^{( 2 , n )} \\ ⋮ \\ {g}_{yx}^{( M t , n )}\end{matrix} ] = {A}^{†} [ \begin{matrix}{\hat{h}}_{yx}^{( 1 , n )} \\ {\hat{h}}_{yx}^{( 2 , n )} \\ ⋮ \\ {\hat{h}}_{yx}^{( K , n )}\end{matrix} ] = {[ \begin{matrix}{e}^{- j 2 π1 \cdot Δ f {τ}_{1}} & {e}^{- j 2 π1 \cdot Δ f {τ}_{2}} & … & {e}^{- j 2 π1 \cdot Δ f {τ}_{M t}} \\ {e}^{- j 2 π2 \cdot Δ f {τ}_{1}} & {e}^{- j 2 π2 \cdot Δ f {τ}_{2}} & … & {e}^{- j 2 π2 \cdot Δ f {τ}_{M t}} \\ ⋮ & ⋮ & ⋱ & ⋮ \\ {e}^{- j 2 πK \cdot Δ f {τ}_{1}} & {e}^{- j 2 πK \cdot Δ f {τ}_{2}} & … & {e}^{- j 2 πK \cdot Δ f {τ}_{M t}}\end{matrix} ]}^{†} [ \begin{matrix}{\hat{h}}_{yx}^{( 1 , n )} \\ {\hat{h}}_{yx}^{( 2 , n )} \\ ⋮ \\ {\hat{h}}_{yx}^{( K , n )}\end{matrix} ] \qquad ( 6 )$$

The PDP calculation unit 23b calculates the PDP, which is a parameter indicating the averaged power-to-delay characteristics of the delay taps, by using the impulse response g_{yx}^{(mt,n)} calculated by the impulse response calculation unit 23a. The PDP normalized by the total power and expressed in dB units is calculated as in Expression (7).

$${P}_{pdp} ( mt ) = 10 \cdot {log}_{10} ( \frac{{P}_{tap} ( mt )}{{\sum }_{mt = 1}^{M t} {P}_{tap} ( mt )} ) \qquad ( 7 )$$

In Expression (7), Pₜₐₚ(mt) is represented by Expression (8).

$${P}_{tap} ( mt ) = \frac{1}{N} {\sum }_{n = 1}^{N} {\sum }_{y = 1}^{{N}_{RxAnt}} {\sum }_{x = 1}^{{N}_{TxAnt}} {\vert {g}_{yx}^{( mt , n )} \vert}^{2} \qquad ( 8 )$$

It should be noted that, in a case where a PDP for the first delay tap is assumed to include only a non-line-of-sight (NLOS) component being separated from a line-of-sight (LOS) component, the first delay tap Pₜₐₚ(1) is calculated as in Expression (9) using a K factor K_{allNLOS} calculated by the K factor calculation unit 24 which will be described later.

$${p}_{tap} ( 1 ) = \frac{1}{{K}_{allINLOS} + 1} \frac{1}{N} {\sum }_{n = 1}^{N} {\sum }_{y = 1}^{{N}_{RxAnt}} {\sum }_{x = 1}^{{N}_{TxAnt}} {\vert {g}_{yx}^{( 1 , n )} \vert}^{2} \qquad ( 9 )$$

The K factor K_{allNLOS} illustrated in the present example is a parameter indicating a ratio of the power of the LOS to the power of all the NLOS. The K factor can be calculated without being affected by the precoding, for example, by a method described in the following reference document.

Specifically, the K factor calculation unit 24 calculates the K factor K_{allNLOS} from Expression (9) of the following reference document by associating the estimation characteristics h\hat{ }_{yx}^{(k,n)} calculated by the actual propagation path estimation characteristic calculation unit 21 with “V+v(t)” described in Expression (1) of the following reference document.
Reference Document: L. J. Greenstein, et al, “Moment-Method Estimation of the Ricean K-Factor,” in IEEE Communications Letters, Vol. 3, No. 6, pp. 175-176, June 1999

The transmission antenna correlation calculation unit 25 calculates the transmission antenna correlation such that the channel capacity of a known channel model such as the TDL model is equivalent to the actual propagation path channel capacity C_{1Hz}(ξ) calculated by the actual propagation path channel capacity calculation unit 29 which will be described later.

The transmission antenna correlation is defined as the elements of a transmission antenna correlation matrix R_{txcorr}(α) indicating a correlation among the propagation path characteristics from the plurality of transmission antennas Tx#1 to Tx#Nₜₓₐₙₜ to each reception antenna Rx#y.

For example, the transmission antenna correlation matrix R_{txcorr}(α) can be modeled as a matrix that includes a transmission antenna correlation coefficient α as a parameter, as defined in Appendix B of 3GPP (registered trademark) TS38.101-4.

Here, it is assumed that a is a real number of 0 or more and 1 or less. Expressions (10a) to (10d) represent the transmission antenna correlation matrices R_{txcorr}(α) in a case where the number N_{TxAnt} of the transmission antennas is 1 to 4.

$${R}_{txcorr} ( α ) = [ 1 ] \qquad ( 10 a )$$

$${R}_{txcorr} ( α ) = [ \begin{matrix}1 & α \\ {α}^{*} & 1\end{matrix} ] \qquad ( 10 b )$$

$${R}_{txcorr} ( α ) = [ \begin{matrix}1 & {α}^{\frac{1}{4}} & α \\ {α}^{\frac{1}{4} *} & 1 & {α}^{\frac{1}{4}} \\ {α}^{*} & {α}^{\frac{1}{4} *} & 1\end{matrix} ] \qquad ( 10 c )$$

$${R}_{txcorr} ( α ) = [ \begin{matrix}1 & {α}^{\frac{1}{9}} & {α}^{\frac{4}{9}} & α \\ {α}^{\frac{1}{9} *} & 1 & {α}^{\frac{1}{9}} & {α}^{\frac{4}{9}} \\ {α}^{\frac{4}{9} *} & {α}^{\frac{1}{9} *} & 1 & {α}^{\frac{1}{9}} \\ {α}^{*} & {α}^{\frac{4}{9} *} & {α}^{\frac{1}{9} *} & 1\end{matrix} ] \qquad ( 10 d )$$

The simulation propagation path characteristic calculation unit 32 calculates a simulation propagation path matrix Hₛᵢₘ(α,n) indicating the simulation propagation path characteristics of the channel model based on the K factor K_{allNLOS} calculated by the K factor calculation unit 24, the transmission antenna correlation matrix R_{txcorr}(α) calculated by the transmission antenna correlation calculation unit 25, and the reception antenna correlation matrix R_{rxcorr} calculated by the reception antenna correlation calculation unit 26 which will be described later. The simulation propagation path matrix Hₛᵢₘ(α,n) in the frequency domain in a case where the TDL model is used as the channel model is represented as Expression (11).

$${H}_{sim} ( α , n ) = \sqrt{\frac{{K}_{allNLOS}}{{K}_{allNLOS} + 1}} {OnesRot}_{{N}_{RxAnt} \times {N}_{TxAnt}} + \sqrt{\frac{1}{{K}_{allNLOS} + 1}} {L}_{rx} {H}_{iid} ( n ) {{L}_{tx} ( α )}^{H} \qquad ( 11 )$$

Here, Lᵣₓ and Lₜₓ(α) in Expression (11) are represented by Expressions (12a) and (12b). It should be noted that Chol(R) is defined as a Cholesky decomposition of the matrix R.

$${L}_{rx} = Chol ( {R}_{rxcorr} ) \qquad ( 12 a )$$

$${L}_{tx} ( α ) = Chol ( {R}_{txcorr} ( α ) ) \qquad ( 12 b )$$

The reception antenna correlation matrix R_{rxcorr} included in Lᵣₓ in Expression (12a) is a reception antenna correlation matrix not including the influence of the lines of sight of the downlink signals from the plurality of transmission antennas Tx#1 to Tx#N_{TxAnt}. A method of calculating the reception antenna correlation matrix R_{rxcorr} not including the influence of the lines of sight will be described later.

In Expression (12b), it is assumed that Lₜₓ(1) in a case where α is 1 is a matrix in which all elements in the leftmost column of the matrix having a size of R_{txcorr}(α) are 1 and all elements in the remaining columns are 0. This is because R_{txcorr}(1) is not a positive definite matrix, and cannot be subjected to Cholesky decomposition.

H_{iid}(n) in Expression (11) is a matrix having the size of N_{RxAnt}×N_{TxAnt} and having elements of a random variable that follows a complex Gaussian distribution with a standard deviation of 1.

OnesRot_{NRxAnt×NTxAnt} in Expression (11) is a matrix having the size of N_{RxAnt}×N_{TxAnt} and in which all elements have a magnitude of 1 and estimation values θ\hat{ }_{R21}(x), θ\hat{ }_{R31}(x), . . . , and θ\hat{ }_{RNRxAnt1}(x) of the relative phases θ_{R21}(x), θ_{R31}(x), . . . , and θ_{RNRxAnt1}(x) of the lines of sight are included, as indicated by Expression (13). Here, θ_{Rab}(x) or θ\hat{ }_{Rab}(x) is a relative phase of a phase of the reception antenna Rx#a with respect to a phase of the reception antenna Rx#b for the line of sight from one transmission antenna Tx#x, or an estimation value of the relative phase.

$${OnesRot}_{{N}_{RxAnt} \times {N}_{TxAnt}} = [ {\hat{v}}_{RLosPh} ( 1 ) , {\hat{v}}_{RLosPh} ( 2 ) , … , {\hat{v}}_{RLosPh} ( {N}_{TxAnt} ) ] \qquad ( 13 )$$

$${\hat{v}}_{RLosPh} ( x ) = [ \begin{matrix}1 \\ {e}^{j {\hat{θ}}_{R 21} ( x )} \\ {e}^{j {\hat{θ}}_{R 31} ( x )} \\ ⋮ \\ {e}^{j {\hat{θ}}_{R {N}_{RxAnt} 1} ( x )}\end{matrix} ]$$

In the analysis in the environment in which the LOS component is not present (in a case where the K factor K_{allNLOS} is 0), it is not always necessary to calculate the first term including OnesRot_{NRxAnt×NTxAnt} in Expression (11).

The estimation values θ\hat{ }_{R21}(x), θ_{R31}(x), . . . , and θ\hat{ }_{RNRxAnt1}(x) of the relative phases of the lines of sight of the downlink signals from the transmission antenna Tx#x to the reception antennas Rx#1 to Rx#N_{RxAnt} are calculated by the relative phase estimation unit 28 which will be described later.

That is, the first term of the simulation propagation path matrix Hₛᵢₘ(α,n) of Expression (11) is the LOS component including the estimation values θ\hat{ }_{R21}(x), θ\hat{ }_{R31}(x), . . . , and θ\hat{ }_{RNRxAnt1}(x) of the relative phases of the lines of sight. In addition, the second term of the simulation propagation path matrix Hₛᵢₘ(α,n) of Expression (11) represents the NLOS component not including the influence of the LOS component that can be expressed by the estimation values θ\hat{ }_{R21}(x), θ\hat{ }_{R31}(x), . . . , and θ\hat{ }_{RNRxAnt1}(x) of the relative phases of the lines of sight.

As can be seen from Expressions (12a) and (12b), in the simulation propagation path matrix Hₛᵢₘ(α,n) of Expression (11), the reception antenna correlation matrix R_{rxcorr} and the transmission antenna correlation matrix R_{txcorr}(α) are included in the NLOS component.

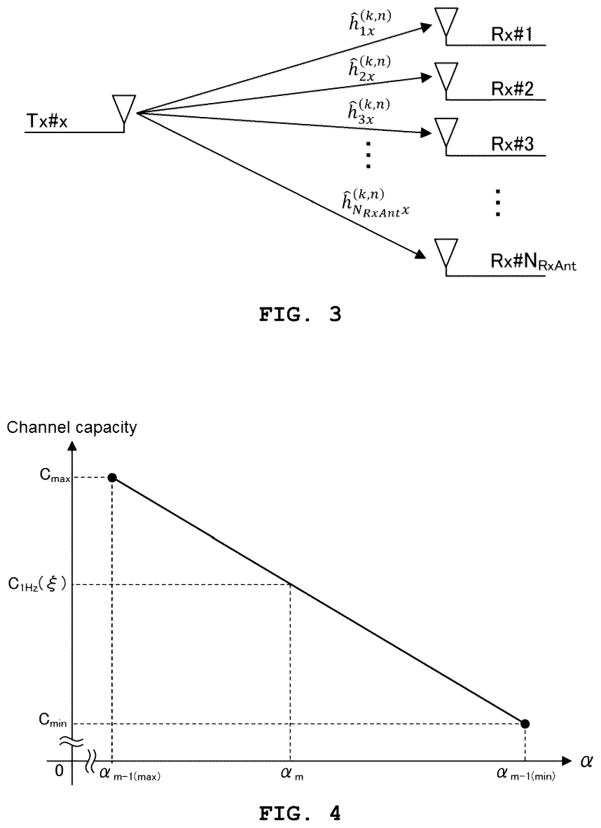

As illustrated in FIG. 3, the reception antenna correlation calculation unit 26 calculates the reception antenna correlation matrix R_{rxcorr} having, as elements, reception antenna correlations which are correlations among estimation characteristics h\hat{ }_{yx}^{(k,n)} from the transmission antenna Tx#x to the reception antennas Rx#1 to Rx#N_{RxAnt}.

The influence of the precoding on the reception antenna correlation can be described as below. The reception antenna correlation can be calculated as defined without being affected by the precoding, unlike the transmission antenna correlation.

For example, a correlation matrix R_{rxcorr_LOS}(x) including the influence of the lines of sight on the transmission antenna Tx#x is represented by Expression (14).

$${R}_{rxcorr \_ LOS} ( x ) = \frac{1}{NK} {\sum }_{n = 1}^{N} {\sum }_{k = 1}^{K} \{ {[ \begin{matrix}{\hat{h}}_{1 x}^{( k , n )} \\ {\hat{h}}_{2 x}^{( k , n )} \\ {\hat{h}}_{3 x}^{( k , n )} \\ ⋮ \\ {\hat{h}}_{{N}_{RxAnt} x}^{( k , n )}\end{matrix} ] [ \begin{matrix}{\hat{h}}_{1 x}^{( k , n )} \\ {\hat{h}}_{2 x}^{( k , n )} \\ {\hat{h}}_{3 x}^{( k , n )} \\ ⋮ \\ {\hat{h}}_{{N}_{RxAnt} x}^{( k , n )}\end{matrix} ]}^{H} \} \qquad ( 14 )$$

The values for k and n of the y₁ row and y₂ column component in the correlation matrix R_{rxcorr_LOS}(x) are calculated as the correlation coefficients between h\hat{ }_{y1x}^{(k,n)} and h\hat{ }_{y2x}^{(k,n)}. The correlation coefficient depends on a relative phase between h\hat{ }_{y1x}^{(k,n)} and h\hat{ }_{y2x}^{(k,n)}, as indicated by Expression (15).

$$\begin{matrix}( Relative phase ) = ∠ {\hat{h}}_{{y}_{1} x}^{( k , n )} - {\hat{h}}_{{y}_{2} x}^{( k , n )} \\ = ∠ {\hat{h}}_{{y}_{1} x ( prc )}^{( k , n )} + ∠ {\hat{h}}_{{y}_{1} x ( ch )}^{( k , n )} - ∠ {\hat{h}}_{{y}_{2} x ( prc )}^{( k , n )} - ∠ {\hat{h}}_{{y}_{2} x ( ch )}^{( k , n )}\end{matrix} \qquad ( 15 )$$

Here, the relative phase of Expression (15) includes phases ∠h\hat{ }_{y1x(prc)}^{(k,n)} and ∠h\hat{ }_{y2x(prc)}^{(k,n)} due to the precoding, and phases ∠h\hat{ }_{y1x(ch)}^{(k,n)} and ∠h\hat{ }_{y2x(ch)}^{(k,n)} due to the actual propagation path 110. Here, since the transmission antenna Tx#x is common to one or more reception antennas Rx#1 to Rx#N_{RxAnt}, the phases ∠h\hat{ }_{y1x(prc)}^{(k,n)} and ∠h\hat{ }_{y2x(prc)}^{(k,n)} due to the precoding in Expression (15) are canceled out.

Therefore, the y₁ row and y₂ column component of the correlation matrix R_{rxcorr_LOS}(x) is represented as in Expression (16).

$$\begin{matrix}( {y}_{1} , {y}_{2} ) = \frac{1}{NK} {\sum }_{n = 1}^{N} {\sum }_{k = 1}^{K} \{ {\hat{h}}_{{y}_{1} x}^{( k , n )} {\hat{h}}_{{y}_{2} x}^{{( k , n )}^{*}} \} = \\ \frac{1}{NK} {\sum }_{n = 1}^{N} {\sum }_{k = 1}^{K} \{ \vert {\hat{h}}_{{y}_{1} x}^{( k , n )} \vert \vert {\hat{h}}_{{y}_{2} x}^{( k , n )} \vert {e}^{j ( ∠ {\hat{h}}_{{y}_{1} x}^{( k , n )} - ∠ {\hat{h}}_{{y}_{2} x}^{( k , n )} )} \} \\ = \frac{1}{NK} {\sum }_{n = 1}^{N} {\sum }_{k = 1}^{K} \{ \vert {\hat{h}}_{{y}_{1} x}^{( k , n )} \vert \vert {\hat{h}}_{{y}_{2} x}^{( k , n )} \vert {e}^{j ( ∠ {\hat{h}}_{{y}_{1} x ( ch )}^{( k , n )} - ∠ {\hat{h}}_{{y}_{2} x ( ch )}^{( k , n )} )} \}\end{matrix} \qquad ( 16 )$$

As can be seen from Expression (16), the reception antenna correlation can be directly calculated without being affected by the phases ∠h\hat{ }_{y1x(prc)}^{(k,n)} and ∠h\hat{ }_{y2x(prc)}^{(k,n)} due to the precoding.

The relative phase estimation unit 28 calculates estimation values θ\hat{ }_{R21}(x), θ\hat{ }_{R31}(x), . . . , and θ_{RNRxAnt1}(x) of the relative phases θ_{R21}(x), θ_{R31}(x), . . . , and θ_{RNRxAnt1}(x) Of the lines of sight included in the correlation matrix R_{rxcorr_LOS}(x) and the simulation propagation path matrix Hₛᵢₘ(α,n).

Hereinafter, a procedure in which the relative phase estimation unit 28 calculates the estimation values θ\hat{ }_{R21}(x), θ\hat{ }_{R31}(x), . . . , and θ\hat{ }_{RNRxAnt1}(x) of the relative phase of the lines of sight will be described.

For each transmission antenna Tx#x, a function f_{RLosPh}(x) indicated by Expression (17) is defined. It should be noted that |z| indicates a magnitude of a complex number z, and f_{RLosPh}(x) is a positive real number.

$${f}_{RLosPh} ( x ) = \vert {{v}_{RLosPh} ( x )}^{H} {R}_{rxcorr \_ LOS} ( x ) {v}_{RLosPh} ( x ) \vert \qquad ( 17 )$$

$${v}_{RLosPh} ( x ) = [ \begin{matrix}1 \\ {e}^{j {θ}_{R 21} ( x )} \\ {e}^{j {θ}_{R 31} ( x )} \\ ⋮ \\ {e}^{j {θ}_{R {N}_{RxAnt} 1} ( x )}\end{matrix} ]$$

As a method of calculating the estimation values θ\hat{ }_{R21}(x), θ\hat{ }_{R31}(x), . . . , and θ\hat{ }_{RNRxAnt1}(x) of the relative phases by the relative phase estimation unit 28, for example, any one of the following two methods can be considered.

### Method 1 of Calculating Estimation Value of Relative Phase

The relative phase estimation unit 28 calculates the relative phases θ_{R21}(x), θ_{R31}(x), . . . , and θ_{RNRxAnt1}(x) in which f_{RLosPh}(x) is maximized by numerical calculation using the steepest descent method, using Expressions (18a), (18b), and (18c).

$${θ}_{R 21} ( x ) ← {θ}_{R 21} ( x ) + η \frac{\partial {f}_{RLosPh} ( x )}{\partial {θ}_{R 21} ( x )} \qquad ( 18 a )$$

$${θ}_{R 31} ( x ) ← {θ}_{R 31} ( x ) + η \frac{\partial {f}_{RLosPh} ( x )}{\partial {θ}_{R 31} ( x )} \qquad ( 18 b )$$

$${θ}_{R {N}_{RxAnt} 1} ( x ) ← {θ}_{R {N}_{RxAnt} 1} ( x ) + η \frac{\partial {f}_{RLosPh} ( x )}{\partial {θ}_{R {N}_{RxAnt} 1} ( x )} \qquad ( 18 c )$$

It is desirable that the parameter n in Expressions (18a), (18b), and (18c) is set to an appropriate value by looking at the convergence speed and stability of the relative phases θ_{R21}(x), θ_{R31}(x), . . . , and θ_{RNRxAnt1}(x).

First, the relative phase estimation unit 28 determines initial values of the relative phases θ_{R21}(x), θ_{R31}(x), . . . , and θ_{RNRxAnt1}(x). For example, the initial values of all the relative phases may be zero.

Next, the relative phase estimation unit 28 updates the relative phases θ_{R21}(x), θ_{R31}(x), . . . , and θ_{RNRxAnt1}(x) by using Expressions (18a), (18b), and (18c), respectively. It should be noted that numerical differentiation is used for the partial differentiation.

Next, the relative phase estimation unit 28 repeats the calculation of the expressions (18a), (18b), and (18c) until the update contents of each of the relative phases θ_{R21}(x), θ_{R31}(x), . . . , and θ_{RNRxAnt1}(x) are sufficiently small, and sets the converged relative phase as the estimation values θ\hat{ }_{R21}(x), θ\hat{ }_{R31}(x), . . . , and θ\hat{ }_{RNRxAnt1}(x) of the relative phases.

### Method 2 of Calculating Estimation Value of Relative Phase

The relative phase estimation unit 28 approximately calculates the estimation values θ\hat{ }_{R21}(x), θ\hat{ }_{R31}(x), . . . , and θ\hat{ }_{RNRxAnt1}(x) of the relative phases as follows.

The relative phase estimation unit 28 calculates the estimation values θ\hat{ }_{R21}(x), θ\hat{ }_{R31}(x), . . . , and θ_{RNRxAnt1}(x) of the relative phases using an eigenvector u (bold) corresponding to the maximum eigenvalue obtained by performing the eigenvalue decomposition on the correlation matrix R_{rxcorr_LOS}(x) including the influence of the lines of sight, as indicated by Expressions (19a), (19b), (19c), and (19d).

$${\hat{θ}}_{R 21} ( x ) \approx ∠ {u}_{2} ( x ) - ∠ {u}_{1} ( x ) = {θ}_{2} ( x ) - {θ}_{1} ( x ) \qquad ( 19 a )$$

$${\hat{θ}}_{R 31} ( x ) \approx ∠ {u}_{3} ( x ) - ∠ {u}_{1} ( x ) = {θ}_{3} ( x ) - {θ}_{1} ( x ) \qquad ( 19 b )$$

$${\hat{θ}}_{{RN}_{RxAnt} 1} ( x ) \approx ∠ {u}_{{N}_{RxAnt}} ( x ) - ∠ {u}_{1} ( x ) = {θ}_{{N}_{RxAnt}} ( x ) - {θ}_{1} ( x ) \qquad ( 19 c )$$

$$Here , u = [ \begin{matrix}{u}_{1} ( x ) \\ {u}_{2} ( x ) \\ {u}_{3} ( x ) \\ ⋮ \\ {u}_{{N}_{RxAnt}} ( x )\end{matrix} ] \approx κ [ \begin{matrix}{e}^{j {θ}_{1} ( x )} \\ {e}^{j {θ}_{2} ( x )} \\ {e}^{j {θ}_{3} ( x )} \\ ⋮ \\ {e}^{j {θ}_{{N}_{RxAnt}} ( x )}\end{matrix} ] \qquad ( 19 d )$$

It should be noted that Expression (19d) is an approximation assuming that the magnitudes of the respective elements of the eigenvector u (bold) in which f_{RLosPh}(x) is maximized are equal, and κ is a constant of a real number.

By using the method 2, approximate values to some extent can be calculated while suppressing the calculation load as compared with the method 1.

Hereinafter, a supplementary description will be made for the fact that the relative phases θ_{R21}(x), θ_{R31}(x), . . . , and θ_{RNRxAnt1}(x) in which f_{RLosPh}(x) is maximized are appropriate as the estimation values θ\hat{ }_{R21}(x), θ_{R31}(x), . . . , θ\hat{ }_{RNRxAnt1}(x) of the relative phases of the lines of sight.

The propagation path matrix H(n) of the MIMO propagation path including the lines of sight and the non-lines of sight can be represented as Expression (20) as in Expression (11).

$$H ( n ) = \sqrt{\frac{{K}_{aHNLOS}}{{K}_{aHNLOS} + 1}} [ {v}_{RLosPh 0} ( 1 ) , {v}_{RLosPh 0} ( 2 ) , … , {v}_{RLosPh 0} ( {N}_{TxAnt} ) ] + \sqrt{\frac{1}{{K}_{aHNLOS} + 1}} {L}_{rx} {H}_{iid} ( n ) {L}_{tx}^{H} \qquad ( 20 )$$

The correlation matrix R_{rxcorr_LOS}(x) including the influence of the lines of sight is calculated as in Expression (21) using a column vector v (bold) _{RLosPh0}(x) consisting of an element in the x-th column of H(n) in Expression (20).

$${R}_{rxcorr \_ LOS} = \frac{1}{N} {\sum }_{n = 1}^{N} \{ \sqrt{\frac{{K}_{allNLOS}}{{K}_{allNLOS} + 1}} v \text{?} ( x ) + \sqrt{\frac{1}{{K}_{allNLOS} + 1}} {L}_{rx} {h}_{iid} ( n ) \} {\{ \sqrt{\frac{{K}_{allNLOS}}{{K}_{allNLOS} + 1}} v \text{?} ( x ) + \sqrt{\frac{1}{{K}_{allNLOS} + 1}} {L}_{rx} {h}_{iid} ( n ) \}}^{H} = \frac{1}{N} {\sum }_{n = 1}^{N} \{ \frac{{K}_{allNLOS}}{{K}_{allNLOS} + 1} v \text{?} ( x ) \text{?} ( x ) \text{?} + \frac{1}{{K}_{allNLOS} + 1} {L}_{rx} {h}_{iid} ( n ) {{h}_{iid} ( n )}^{H} {L}_{rx}^{H} + \sqrt{\frac{{K}_{allNLOS}}{{K}_{allNLOS} + 1}} v \text{?} ( x ) \sqrt{\frac{1}{{K}_{allNLOS} + 1}} {{h}_{iid} ( n )}^{H} {L}_{rx}^{H} + \sqrt{\frac{1}{{K}_{allNLOS} + 1}} {L}_{rx} {h}_{iid} ( n ) \sqrt{\frac{{K}_{allNLOS}}{{K}_{allNLOS} + 1}} v \text{?} {( x )}^{H} \} \qquad ( 21 )$$

$$\text{?} \text{indicates text missing or illegible when filed}$$

Here, h (bold) _{iid}(n) is a column vector consisting of an element in the x-th column of H_{iid}(n).

In a case where N>>1, the approximation as indicated by Expression (22) is established.

$${R}_{rxcorr \_ LOS} ( x ) \approx \frac{1}{N} {\sum }_{n = 1}^{N} \{ \frac{{K}_{allNLOS}}{{K}_{allNLOS} + 1} {v}_{RLosPh 0} ( x ) {{v}_{RLosPh 0} ( x )}^{H} + \frac{1}{{K}_{allNLOS} + 1} {L}_{rx} {h}_{iid} ( n ) {{h}_{iid} ( n )}^{H} {L}_{rx}^{H} \} = \frac{{K}_{allNLOS}}{{K}_{allNLOS} + 1} \frac{1}{N} {\sum }_{n = 1}^{N} \{ {v}_{RLosPh 0} ( x ) {{v}_{RLosPh 0} ( x )}^{H} \} + \frac{1}{{K}_{allNLOS} + 1} {L}_{rx} \frac{1}{N} {\sum }_{n = 1}^{N} \{ {h}_{iid} ( n ) {{h}_{iid} ( n )}^{H} \} {L}_{rx}^{H} \approx \frac{{K}_{allNLOS}}{{K}_{allNLOS} + 1} {v}_{RLosPh 0} ( x ) {{v}_{RLosPh 0} ( x )}^{H} + \frac{1}{{K}_{allNLOS} + 1} {L}_{rx} {L}_{rx}^{H} \qquad ( 22 )$$

In Expression (17), f_{RLosPh}(x) is transformed as in Expression (23) using Expression (22).

$${f}_{RLosPh} ( x ) = \vert {{v}_{RLosPh} ( x )}^{H} {R}_{rxcorr \_ LOS} ( x ) {v}_{RLosPh} ( x ) \vert = \vert {{v}_{RLosPh} ( x )}^{H} \{ \frac{{K}_{allNLOS}}{{K}_{allNLOS} + 1} {v}_{RLosPh 0} ( x ) {{v}_{RLosPh 0} ( x )}^{H} + \frac{1}{{K}_{allNLOS} + 1} {L}_{rx} {L}_{rx}^{H} \} {v}_{RLosPh} ( x ) \vert = \frac{1}{{K}_{allNLOS} + 1} \vert {{v}_{RLosPh} ( x )}^{H} \{ {K}_{allNLOS} {v}_{RLosPh 0} ( x ) {{v}_{RLosPh 0} ( x )}^{H} + {L}_{rx} {L}_{rx}^{H} \} {v}_{RLosPh} ( x ) \vert = \frac{1}{{K}_{allNLOS} + 1} \vert {K}_{allNLOS} {{v}_{RLosPh} ( x )}^{H} \{ {v}_{RLosPh 0} ( x ) {{v}_{RLosPh 0} ( x )}^{H} \} {v}_{RLosPh} ( x ) + {{v}_{RLosPh} ( x )}^{H} \{ {L}_{rx} {L}_{rx}^{H} \} {v}_{RLosPh} ( x ) \vert \qquad ( 23 )$$

It can be seen that the relative phase in which the first term in the absolute value of Expression (23) is maximized is the relative phase θ_{R21}(x), θ_{R31}(x), . . . , θ_{RNRxAnt1}(x) of the lines of sight. That is, considering that there is a high possibility that the statistical average of the second term in the absolute value of Expression (23) is close to zero, it can be seen that setting the relative phases θ_{R21}(x), θ_{R31}(x), . . . , and θ_{RNRxAnt1}(x) in which f_{RLosPh}(x) is maximized to the estimation values θ\hat{ }_{R21}(x), θ\hat{ }_{R31}(x), . . . , and θ\hat{ }_{RNRxAnt1}(x) of the relative phases of the lines of sight is an appropriate approximation.

Hereinafter, a procedure of the reception antenna correlation calculation unit 26 calculating the correlation matrix R_{rxcorr_NLOS}(x) in which the influence of the lines of sight is excluded from the correlation matrix R_{rxcorr_LOS}(x) for each transmission antenna Tx#x using the K factor calculated by the K factor calculation unit 24 and the estimation values θ\hat{ }_{R21}(x), θ_{R31}(x), . . . , and θ\hat{ }_{RNRxAnt1}(x) of the relative phases calculated by the relative phase estimation unit 28 will be described.

First, as indicated by Expression (24), the reception antenna correlation calculation unit 26 calculates a correlation matrix R_{rxcorr_LOSadj} (x) in which the phase is adjusted such that all the phases of the lines of sight are zero (in the real axis direction on the complex plane). It should be noted that diag(v (bold) \hat{ }_{RLosPh}(x)) in Expression (24) is an operator indicating a diagonal matrix having elements of the column vector v (bold)\hat{ }_{RLosPh}(x) as diagonal components. In addition, v (bold)\hat{ }_{RLosPh}(x)⁺ is a column vector obtained by taking a conjugate of each element of the column vector v (bold)\hat{ }_{RLosPh}(x).

$${R}_{rxcorr \_ LOSadj} ( x ) = diag ( {{\hat{v}}_{RLosPh} ( x )}^{*} ) {R}_{rxcorr \_ LOS} ( x ) diag ( {\hat{v}}_{RLosPh} ( x ) ) \qquad ( 24 )$$

Next, the reception antenna correlation calculation unit 26 calculates a correlation matrix R_{rxcorr_NLOS}(x) excluding the influence of the lines of sight as indicated by Expression (25). It should be noted that, in Expression (25), Ones_{NRxAnt×NRxAnt} is a matrix having a size of N_{RxAnt}×N_{RxAnt} in which all elements are 1.

$${R}_{rxcorr \_ NLOS} ( x ) = ( {K}_{allNLOS} + 1 ) {R}_{rxcorr \_ LOSadj} ( x ) - {K}_{allNLOS} {Ones}_{{N}_{RxAnt} \times {N}_{RxAnt}} \qquad ( 25 )$$

Hereinafter, the validity of Expression (25) will be described.

In a case where the reception antenna correlation of the NLOS signal (non-line-of-sight signal) for two channels from the common transmission antenna Tx#x to the reception antenna Rx#i and the reception antenna Rx#j is ρᵢⱼ, the propagation path characteristics of the two channels can be written as Expressions (26a) and (26b) using the K factor K_{allNLOS}, respectively.

$${h}_{ix}^{( k , n )} = \sqrt{{K}_{allNLOS}} {e}^{j ( {θ}_{LOSix} + 2 π {kf}_{SCS} {τ}_{LOS} )} + {n}_{i}^{( k , n )} \qquad ( 26 a )$$

$${h}_{jx}^{( k , n )} = \sqrt{{K}_{allNLOS}} {e}^{j ( {θ}_{LOSjx} + 2 π {kf}_{SCS} {τ}_{LOS} )} + {ρ}_{ij} {n}_{i}^{( k , n )} + {n}_{j}^{( k , n )} \sqrt{1 - {ρ}_{ij}^{2}} \qquad ( 26 b )$$

In Expressions (26a) and (26b), f_{SCS} is a sample interval in the frequency axis direction, and τ_{LOS} is a propagation delay time of the LOS component. The complex random variables nᵢ^{(k,n)} and nⱼ^{(k,n)} are random variables of a complex Gaussian distribution that are uncorrelated with each other and have a standard deviation of 1.

In this case, the i-th row and j-th column component of the correlation matrix R_{rxcorr_LOS}(x) for each transmission antenna Tx#x is as in Expression (27). It should be noted that, in Expression (27), a statistical error is excluded because the number of samples used for the average is sufficiently large.

$$( i , j ) component of {R}_{rxcorr \_ LOS} ( x ) = \frac{〈 {h}_{ix}^{( k , n )} {h}_{jx}^{{( k , n )}^{*}} 〉}{\sqrt{〈 {h}_{ix}^{( k , n )} {h}_{ix}^{{( k , n )}^{*}} 〉} \sqrt{〈 {h}_{jx}^{( k , n )} {h}_{jx}^{{( k , n )}^{*}} 〉}} = \frac{{K}_{allNLOS} {e}^{j ( {θ}_{LOSix} - {θ}_{LOSjx} )} + {ρ}_{ij}}{{K}_{allNLOS} + 1} = \frac{{K}_{allNLOS} {e}^{j ( {θ}_{Ri 1} - {θ}_{Rj 1} )} + {ρ}_{ij}}{{K}_{allNLOS} + 1} \qquad ( 27 )$$

In Expression (27), a notation such as <x^{(k,n)}> represents an average (an average for the subcarrier number k and the OFDM symbol number n) using a sufficient number of samples of x^{(k,n)}.

Assuming that the relative phases of the lines of sight in one or more reception antennas Rx#1 to Rx#N_{RxAnt} can be accurately estimated, the i-th row and j-th column component r\hat{ }_{Rij} of the correlation matrix R_{rxcorr_LOSadj}(x) of which the phase is adjusted such that all phases of the lines of sight are zero is as indicated by Expression (28).

$${\hat{r}}_{Rij} = {e}^{- j {\hat{θ}}_{Ri 1}} \frac{{K}_{allNLOS} {e}^{j ( {θ}_{Ri 1} - {θ}_{Rj 1} )} + {ρ}_{ij}}{{K}_{allNLOS} +} {e}^{j {\hat{θ}}_{Rj 1}} \approx \frac{{K}_{allNLOS} + {ρ}_{ij} {e}^{- j ( {\hat{θ}}_{Ri 1} - {\hat{θ}}_{Rj 1} )}}{{K}_{allNLOS} + 1} = \frac{{K}_{allNLOS} + {r}_{Rij}}{{K}_{allNLOS} + 1} \qquad ( 28 )$$

$$Here , {r}_{Rij} = {ρ}_{ij} {e}^{- j ( {\hat{θ}}_{Ri 1} - {\hat{θ}}_{Rj 1} )}$$

It should be noted that, in Expression (28), the i-th row and j-th column component of the correlation matrix R_{rxcorr_NLOS}(x) excluding the influence of the lines of sight is denoted by r_{Rij}.

Expression (28) can be rewritten as Expression (29).

$${r}_{Rij} = ( {K}_{allNLOS} + 1 ) {\hat{r}}_{Rij} - {K}_{allNLOS} \qquad ( 29 )$$

In a case where the i-th row and j-th column components of Expression (29) are summarized for all elements, R_{rxcorr_NLOS}(x) of Expression (25) is obtained.

The reception antenna correlation calculation unit 26 calculates the reception antenna correlation matrix R_{rxcorr} indicated by Expression (30) by averaging the correlation matrix R_{rxcorr_NLOS}(x) of Expression (25) for all the transmission antennas Tx#x.

$${R}_{rxcorr} = \frac{1}{{N}_{TxAnt}} {\sum }_{x = 1}^{{N}_{TxAnt}} {R}_{rxcorr \_ NLOS} ( x ) \qquad ( 30 )$$

The reception antenna correlation matrix R_{rxcorr} obtained by Expression (30) is a correlation matrix not including the influence of the lines of sight, and is input to Lᵣₓ of Expression (11). For the analysis in the environment in which the LOS component is not present (in a case where the K factor K_{allNLOS} is 0), the correlation matrix R_{rxcorr_NLOS}(x) in which the influence of the lines of sight is excluded can be replaced with the correlation matrix R_{rxcorr_LOS}(x) before the influence of the lines of sight is excluded.

The actual propagation path channel capacity calculation unit 29 calculates a channel capacity Co [bit/sec/HZ] of the actual propagation path 110 from the estimation characteristics h\hat{ }_{yx}^{(k,n)} calculated by the actual propagation path estimation characteristic calculation unit 21. Here, the channel capacity Co is a channel capacity at each (k,n) to which the RS is allocated. It can be said that the channel capacity is an upper limit of a theoretical throughput and is an indicator indicating the expectation of the attainable throughput. The throughput is determined by a modulation method, an error correction method, a wireless resource allocation amount, and the like.

Under the condition that the CSI is not used in the base station 100, the channel capacity Co is calculated by Expression (31).

$${C}_{0} ( k , n , ξ ) = {log}_{2} det ( I + \frac{ξ}{{N}_{TxAnt}} \hat{H} ( k , n ) {\hat{H} ( k , n )}^{H} ) = {\sum }_{i = 1}^{min \{ {N}_{TxAnt} , {N}_{RxAnt} \}} {log}_{2} ( 1 + \frac{ξ}{{N}_{TxAnt}} {λ}_{i}^{( k , n )} ) \qquad ( 31 )$$

Here, ξ is a signal-to-noise ratio (SNR) (linear value) per reception antenna Rx#y. λᵢ^{(k,n)} is an i-th eigenvalue of H\hat{ }(k,n) H\hat{ }(k,n)^{H}. The index i is a value from 1 to a smaller value out of N_{TxAnt} and N_{RxAnt}. H\hat{ }(k,n)^{H} is a conjugate transpose of the matrix H\hat{ }(k,n) of the estimation characteristics of the actual propagation path matrix.

Further, the actual propagation path channel capacity calculation unit 29 calculates an actual propagation path channel capacity C_{1Hz}(ξ) [bit/sec/Hz], which is an average of the channel capacities Co of the actual propagation path 110 in a bandwidth in which the number of subcarriers is K and the number of OFDM symbols is N, in accordance with Expression (32).

$${C}_{1 H z} ( ξ ) = \frac{1}{NK} {\sum }_{n = 1}^{N} {\sum }_{k = 1}^{K} {C}_{0} ( k , n , ξ ) \qquad ( 32 )$$

As described below, the simulation channel capacity calculation unit 30 calculates a simulation channel capacity C_{sim1Hz}(ξ,α) of the channel model from a simulation propagation path matrix Hₛᵢₘ(α,n) calculated by the simulation propagation path characteristic calculation unit 32.

Here, it is assumed that, for the simulation propagation path matrix Hₛᵢₘ(α,n) obtained by Expression (11), the eigenvalues in a case where Hₛᵢₘ(α,n) Hₛᵢₘ(α,n)^{H} is subjected to eigenvalue decomposition are λ^{psim(α,n)}. The index p is a value from 1 to a smaller value out of N_{TxAnt} and N_{RxAnt}.

In this case, the simulation channel capacity calculation unit 30 calculates the simulation channel capacity C_{sim1Hz}(ξ,α), which is an average value of the channel capacities of the simulation propagation path matrices Hₛᵢₘ(α,n), using the simulation propagation path matrix Hₛᵢₘ(α,n) for N=N_{sym} pieces, as in Expression (33). The specific numerical value of N_{sym} needs to be adjusted in view of the balance between the processing time and the variation in the result, but for example, N_{sym} can be set to a value of about 1000.

$${C}_{Sim 1 H z} ( ξ , α ) = \frac{1}{{N}_{sym}} {\sum }_{n = 1}^{{N}_{sym}} {\sum }_{p = 1}^{min \{ {N}_{TxAnt} , {N}_{RxAnt} \}} {log}_{2} ( 1 + \frac{ξ}{{N}_{TxAnt}} {λ}_{p}^{sim ( α , n )} ) \qquad ( 33 )$$

$$p ∈ \{ 1 , 2 , … , min \{ {N}_{TxAnt} , {N}_{RxAnt} \} \}$$

The transmission antenna correlation coefficient estimation unit 27 estimates the transmission antenna correlation coefficient α such that a difference between the actual propagation path channel capacity C_{1Hz}(ξ) calculated by the actual propagation path channel capacity calculation unit 29 and the simulation channel capacity C_{sim1Hz}(ξ,α) calculated by the simulation channel capacity calculation unit 30 is smaller than a specified value.

For example, the transmission antenna correlation coefficient estimation unit 27 obtains α such that the simulation channel capacity C_{sim1Hz}(ξ,α) is substantially equal to the actual propagation path channel capacity C_{1Hz}(ξ) in a case where ξ=1000 (that is, the SNR is 30 dB). That is, the actual propagation path channel capacity C_{1Hz}(ξ) is a target value in a case of adjusting the simulation channel capacity C_{sim1Hz}(ξ,α) of the channel model.

The transmission antenna correlation calculation unit 25 calculates the transmission antenna correlation indicating the correlation among the estimation characteristics h\hat{ }_{yx}^{(k,n)} from the plurality of transmission antennas Tx#1 to Tx#N_{TxAnt} to each reception antenna Rx#y by the transmission antenna correlation matrix R_{txcorr}(α) by substituting the transmission antenna correlation coefficient α estimated by the transmission antenna correlation coefficient estimation unit 27 into the transmission antenna correlation matrix R_{txcorr}(α).

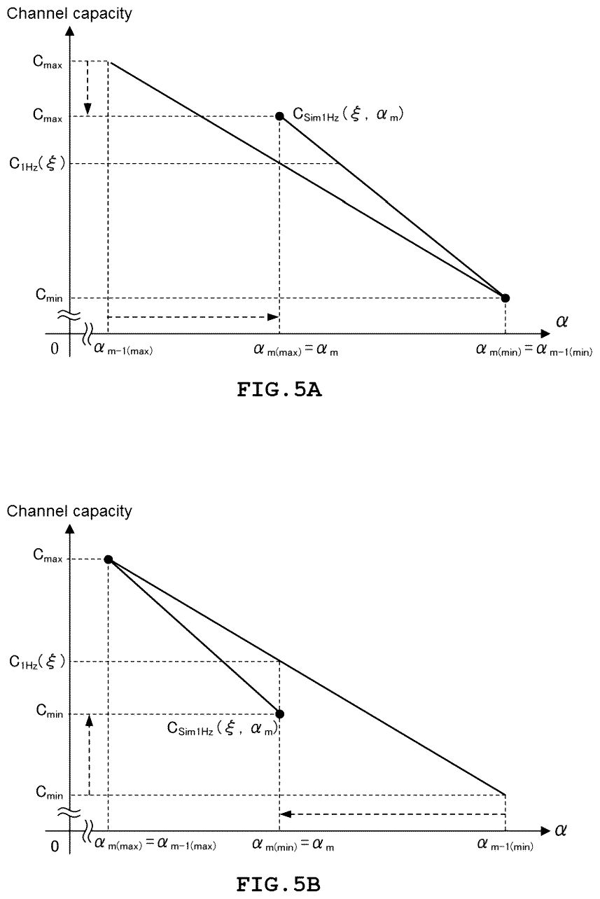

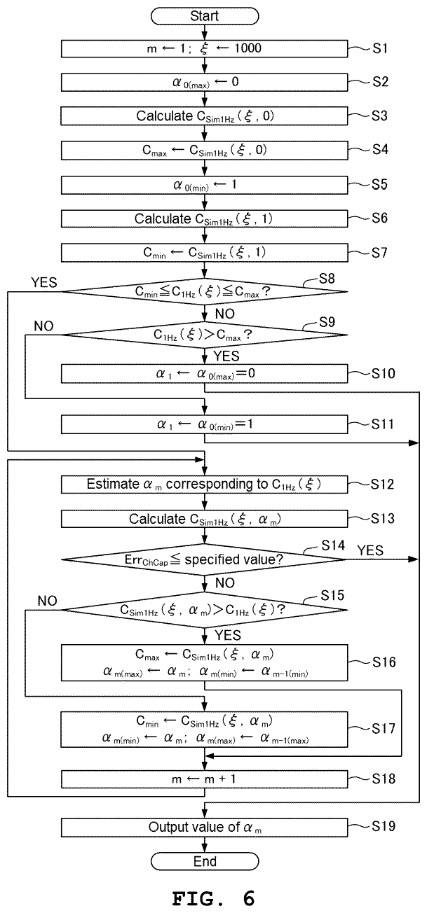

Hereinafter, specific examples of processing of the transmission antenna correlation coefficient estimation unit 27, the simulation channel capacity calculation unit 30, and the simulation propagation path characteristic calculation unit 32 will be described with reference to the graphs of FIGS. 4, 5A, and 5B and the flowchart of FIG. 6. The descriptions that overlap with the descriptions of the configuration of the test system 1 will be appropriately omitted.

As illustrated in FIG. 4, among the values of α in the simulation channel capacity C_{sim1Hz}(ξ,α) of Expression (33), values used in the following processing are described as am, αₘ₋₁₍ₘₐₓ₎/αₘ₋₁₍ₘᵢₙ₎ (m is an integer of 1 or more, and is an index for counting the number of repetitions), and the like. In addition, in narrowing down a range of α and a range of the channel capacity corresponding thereto by the repeated processing, a value of C_{sim1Hz}(ξ,αₘ₋₁₍ₘₐₓ₎ in a case of α=αₘ₋₁₍ₘₐₓ₎ corresponds to an upper limit value Cₘₐₓ of the channel capacity, and a value of C_{sim1Hz}(ξ,αₘ₋₁₍ₘᵢₙ₎) in a case of α=αₘ₋₁₍ₘᵢₙ₎ corresponds to a lower limit value Cₘᵢₙ of the channel capacity. Since C_{sim1Hz}(ξ,α) is considered to be a monotonically decreasing function of α, αₘ₋₁₍ₘₐₓ₎≤αₘ₋₁₍ₘᵢₙ₎ is satisfied.

As illustrated in FIG. 6, first, the transmission antenna correlation coefficient estimation unit 27 sets the initial value of the index m to 1, and sets the value of ξ to, for example, 1000 (step S1).

Then, the transmission antenna correlation coefficient estimation unit 27 sets the value of αₘ₋₁₍ₘₐₓ₎=α₀₍ₘₐₓ₎ to 0 (step S2).

Then, the simulation propagation path characteristic calculation unit 32 calculates the simulation propagation path matrix Hₛᵢₘ(0,n) for N_{sym} pieces. The simulation channel capacity calculation unit 30 calculates the simulation channel capacity C_{sim1Hz}(ξ,0) using the simulation propagation path matrix Hₛᵢₘ(0,n) for N_{sym} pieces (step S3).

Then, the transmission antenna correlation coefficient estimation unit 27 sets the value of Cₘₐₓ to C_{sim1Hz}(ξ,0) (step S4).

Then, the transmission antenna correlation coefficient estimation unit 27 sets the value of αₘ₋₁₍ₘᵢₙ₎=α₀₍ₘᵢₙ₎ to 1 (step S5).

Then, the simulation propagation path characteristic calculation unit 32 calculates a simulation propagation path matrix Hₛᵢₘ(1,n) for N_{sym} pieces. The simulation channel capacity calculation unit 30 calculates the simulation channel capacity C_{sim1Hz}(ξ,1) using the simulation propagation path matrix Hₛᵢₘ(1,n) for N_{sym} pieces (step S6).

Then, the transmission antenna correlation coefficient estimation unit 27 sets the value of Cₘᵢₙ to C_{sim1Hz}(ξ,1) (step S7).

In a case where the actual propagation path channel capacity C_{1Hz}(ξ), which is the channel capacity of the target, is Cₘᵢₙ or more and Cₘₐₓ or less (step S8: YES), the processing of step S12 is executed.

In a case where C_{1Hz}(ξ) of the target is not equal to or greater than Cₘᵢₙ and is not equal to or smaller than Cₘₐₓ (step S8: NO), and C_{1Hz}(ξ) of the target is greater than Cₘₐₓ (step S9: YES), the transmission antenna correlation coefficient estimation unit 27 sets the value of α₁ to α₀₍ₘₐₓ₎=0 (step S10). Then, the processing of step S19 is executed.

On the other hand, in a case where C_{1Hz}(ξ) of the target is smaller than Cₘᵢₙ (step S9: NO), the transmission antenna correlation coefficient estimation unit 27 sets the value of α₁ to α₀₍ₘᵢₙ₎=1 (step S11). Then, the processing of step S19 is executed.

In step S12, the transmission antenna correlation coefficient estimation unit 27 estimates am corresponding to C_{1Hz}(ξ) of the target by Expression (34) (step S12). As illustrated in FIG. 4, Expression (34) is an expression for estimating αₘ in a case where C_{sim1Hz}(ξ,α) is regarded as a linear function of α in a range of αₘ₋₁₍ₘₐₓ₎ to αₘ₋₁₍ₘᵢₙ₎.

$${α}_{m} = {α}_{m - 1 ( min )} + \frac{{C}_{1 H z} ( ξ ) - {C}_{min}}{{C}_{max} - {C}_{min}} ( {α}_{m - 1 ( max )} - {α}_{m - 1 ( min )} ) \qquad ( 34 )$$

Then, the simulation propagation path characteristic calculation unit 32 calculates a simulation propagation path matrix Hₛᵢₘ(αₘ,n) for N_{sym} pieces corresponding to αₘ obtained by Expression (34). The simulation channel capacity calculation unit 30 calculates the simulation channel capacity C_{sim1Hz}(ξ,αₘ) using the simulation propagation path matrix Hₛᵢₘ(αₘ,n) for N_{sym} pieces (step S13).

In a case where an absolute value Err_{ChCap} of a percentage error of C_{1Hz}(ξ) of the target with respect to C_{sim1Hz}(ξ,αₘ) is equal to or smaller than a specified value (for example, 1%) (YES in step S14), the processing of step $19 is executed. Here, the absolute value Err_{ChCap} of the percentage error is calculated by Expression (35). On the other hand, in a case where the absolute value Err_{ChCap} of the percentage error is greater than the specified value (NO in step S14), the processing of step S15 is executed.

$${Err}_{ChCap} = \frac{\vert {C}_{Sim 1 H z} ( ξ , {α}_{m} ) - {C}_{1 H z} ( ξ ) \vert}{{C}_{1 H z} ( ξ )} \times 100 \qquad ( 35 )$$

In a case where C_{sim1Hz}(ξ,αₘ) is greater than C_{1Hz}(ξ) (step S15: YES), the transmission antenna correlation coefficient estimation unit 27 sets the value of Cₘₐₓ to C_{sim1Hz}(ξ,αₘ), the value of αₘ₍ₘₐₓ₎ to αₘ, and the value of αₘ₍ₘᵢₙ₎ to αₘ₋₁₍ₘᵢₙ₎ as illustrated in FIG. 5A (step S16).

In a case where C_{sim1Hz}(ξ,αₘ) is smaller than C_{1Hz}(ξ) (step S15: NO), the transmission antenna correlation coefficient estimation unit 27 sets the value of Cₘᵢₙ to C_{sim1Hz}(ξ,αₘ), the value of αₘ₍ₘᵢₙ₎ to αₘ, and the value of αₘ₍ₘₐₓ₎ to αₘ₋₁₍ₘₐₓ₎ as illustrated in FIG. 5B (step S17).

Then, the transmission antenna correlation coefficient estimation unit 27 increases the current value of the index m by 1 (step S18). Then, the processing of step S12 and subsequent processing are executed again.

In step S19, the transmission antenna correlation coefficient estimation unit 27 outputs the current value of αₘ to the transmission antenna correlation calculation unit 25 (step S19).

As described above, the transmission antenna correlation coefficient estimation unit 27 calculates the value of αₘ while gradually narrowing the range from αₘ₋₁₍ₘₐₓ₎ to αₘ₋₁₍ₘᵢₙ₎, and determines α in which the simulation channel capacity C_{sim1Hz}(ξ,α) close to the actual propagation path channel capacity C_{1Hz}(ξ) is obtained.

Steps S3, S6, and S13 constitute a simulation propagation path characteristic calculation step of calculating a simulation propagation path matrix Hₛᵢₘ(αₘ, n) of the channel model based on the K factor K_{allNLOS}, the transmission antenna correlation matrix R_{txcorr}(α), and the reception antenna correlation matrix R_{rxcorr} and a simulation channel capacity calculation step of calculating the simulation channel capacity C_{sim1Hz}(ξ,α) of the channel model from the simulation propagation path matrix Hₛᵢₘ(αₘ,n).

In the simulation propagation path characteristic calculation step, the simulation propagation path matrix Hₛᵢₘ(α,n) consisting of the sum of the LOS component including the estimation values θ\hat{ }_{R21}(x), θ\hat{ }_{R31}(x), . . . , and θ\hat{ }_{RNRxAnt1}(x) of the relative phases of the lines of sight and the NLOS component not including the influence of the LOS component that can be expressed by the estimation values θ\hat{ }_{R21}(x), θ\hat{ }_{R31}(x), . . . , and θ_{RNRxAnt1}(x) of the relative phases of the lines of sight is calculated.

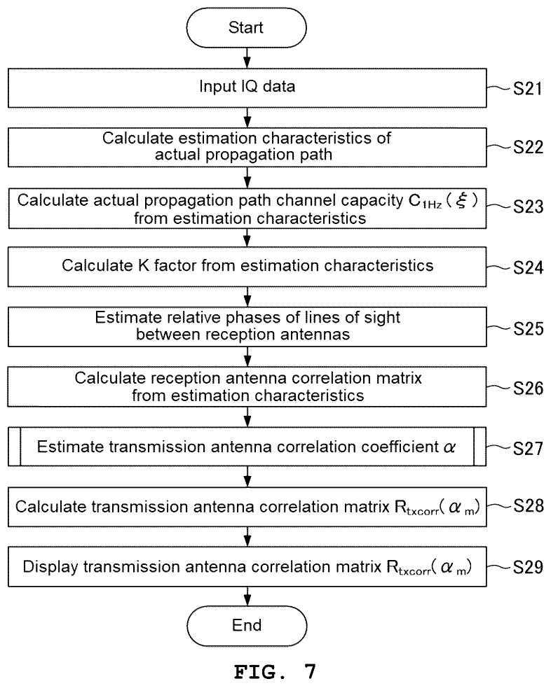

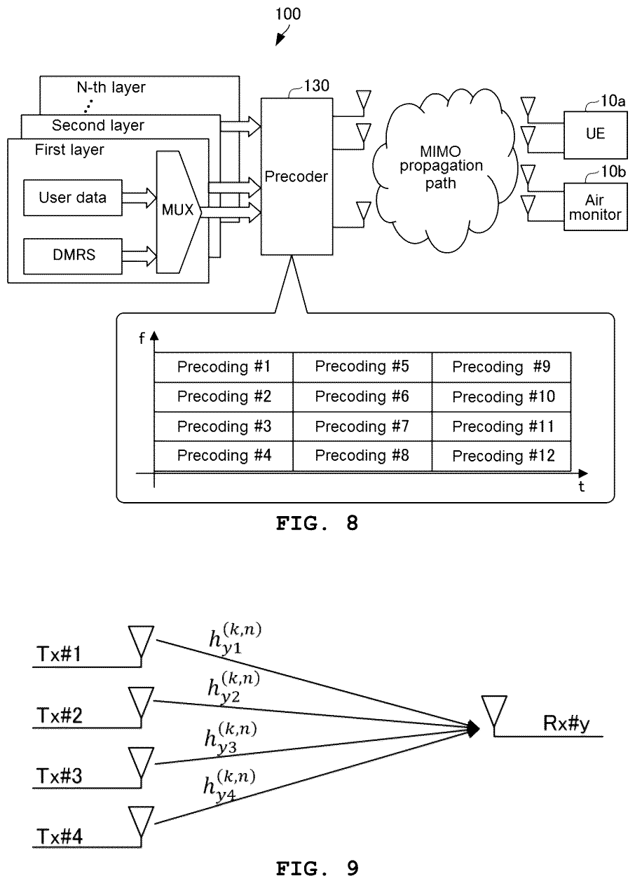

Hereinafter, an example of processing of a transmission antenna correlation estimation method using the test system 1 according to the present embodiment will be described with reference to the flowchart of FIG. 7. The descriptions that overlap with the descriptions of the configuration of the test system 1 will be appropriately omitted.

First, the IQ data of the downlink signal is input from the IQ data output unit 11 of the antenna device 10 to the signal processing unit 20 (step S21).

Then, the actual propagation path estimation characteristic calculation unit 21 calculates the estimation characteristics h\hat{ }_{yx}^{(k,n)} of the propagation path characteristics h_{yx}^{(k,n)} of the plurality of channels constituting the actual propagation path 110 by using the RS included in the IQ data input in step S21 (actual propagation path estimation characteristic calculation step S22).

Then, the actual propagation path channel capacity calculation unit 29 calculates the actual propagation path channel capacity C_{1Hz}(ξ) of the actual propagation path 110 from the estimation characteristics h\hat{ }_{yx}^{(k,n)} calculated by the actual propagation path estimation characteristic calculation unit 21 (actual propagation path channel capacity calculation step S23).

Then, the K factor calculation unit 24 calculates the K factor K_{allNLOS} from the estimation characteristics h\hat{ }_{yx}^{(k,n)} calculated by the actual propagation estimation characteristic calculation unit 21 (K factor calculation step S24).

Then, the relative phase estimation unit 28 calculates the estimation values θ\hat{ }_{R21}(x), θ\hat{ }_{R31}(x), . . . , and θ\hat{ }_{RNRxAnt1}(x) of the relative phases of the lines of sight of the downlink signals from the plurality of transmission antennas Tx#1 to Tx#N_{TxAnt}(x) to the reception antenna Rx#y (relative phase estimation step S25).

Then, the reception antenna correlation calculation unit 26 calculates the reception antenna correlation matrix R_{rxcorr} indicating the reception antenna correlation, which is a correlation among the estimation characteristics h\hat{ }_{yx}^{(k,n)} from each transmission antenna Tx#x to one or more reception antennas Rx#1 to Rx#N_{RxAnt} (reception antenna correlation calculation step S26).

Then, the transmission antenna correlation coefficient estimation unit 27, the simulation channel capacity calculation unit 30, and the simulation propagation path characteristic calculation unit 32 estimate the transmission antenna correlation coefficient x in which the difference between the actual propagation path channel capacity C_{1Hz}(ξ) and the simulation channel capacity C_{sim1Hz}(ξ,α) is smaller than the specified value, by the processing of steps S1 to S19 (transmission antenna correlation coefficient estimation step S27).

Then, the transmission antenna correlation calculation unit 25 substitutes the transmission antenna correlation coefficient am estimated by the transmission antenna correlation coefficient estimation unit 27 into the transmission antenna correlation matrix R_{txcorr}(αₘ), to calculate the transmission antenna correlation, which is the correlation among the estimation characteristics h\hat{ }_{yx}^{(k,n)} from the plurality of transmission antennas Tx#1 to Tx#N_{TxAnt} to each reception antenna Rx#y (transmission antenna correlation calculation step S28).

Then, the signal processing unit 20 displays the transmission antenna correlation matrix R_{txcorr}(αₘ) calculated by the transmission antenna correlation calculation unit 25 on the display unit 41 (step S29).

As described above, in the test system 1 according to the present embodiment, the transmission antenna correlation is calculated such that the actual propagation path channel capacity calculated based on the RS included in the IQ data of the downlink signals propagated from an actual base station 100 to the antenna device 10 and the simulation channel capacity C_{sim1Hz}(ξ,α) by the channel model are equivalent to each other.

Accordingly, in the test system 1 according to the present embodiment, the RS such as a DMRS subjected to precoding can be analyzed, to accurately estimate the transmission antenna correlation.

In a case where the throughput test is performed using the channel model, it may be required to obtain a value close to the throughput achieved in the actual MIMO propagation path environment. Since the channel capacity is a theoretically achievable throughput, in a case of a propagation path having the same channel capacity, it can be said that the propagation path is the propagation path in which the same throughput can be obtained. Therefore, in a case where the test system 1 according to the present embodiment is used, it is possible to perform the throughput test of the DUT 120 using the channel model that can obtain the same throughput as the actual MIMO propagation path.

In addition, in the test system 1 according to the present embodiment, the simulation channel capacity C_{sim1Hz}(ξ,α) is calculated based on the simulation propagation path characteristics consisting of the sum of the LOS component including the information on the relative phases θ_{R21}(x), θ_{R31}(x), . . . , and θ_{RNRxAnt1}(x) of the lines of sight of the downlink signals from the plurality of transmission antennas Tx#1 to Tx#N_{TxAnt} to the reception antennas Rx#y and the NLOS component not including the influence of the lines of sight.

As a result, in the test system 1 according to the present embodiment, it is possible to calculate the simulation channel capacity C_{sim1Hz}(ξ,α) that reflects the phase relationship in the LOS component, similarly to the phase relationship in the actual IQ data.

Further, the test system 1 according to the present embodiment can perform the test of the DUT 120 in a form in which the statistical propagation path characteristics of the actual propagation path 110 are reproduced by using the simulation propagation path characteristics.

In the present embodiment described above, although the base station 100 is the network-side transmission/reception device that transmits the downlink signal to the actual propagation path 110, for example, an access point of Wi-Fi (registered trademark) may be used as the network-side transmission/reception device instead of the base station.

### DESCRIPTION OF REFERENCE NUMERALS AND SIGNS

1 Test system
10 Antenna device
11 IQ data output unit
15 Test device
20 Signal processing unit
21 Actual propagation path estimation characteristic calculation unit
22 Parameter calculation unit
24 K factor calculation unit
25 Transmission antenna correlation calculation unit
26 Reception antenna correlation calculation unit
27 Transmission antenna correlation coefficient estimation unit
28 Relative phase estimation unit
29 Actual propagation path channel capacity calculation unit
30 Simulation channel capacity calculation unit
32 Simulation propagation path characteristic calculation unit
40 Simulation propagation path
41 Display unit
100 Base station (network-side transmission/reception device)
110 Actual propagation path
120 DUT
Rx#1 to Rx#N_{RxAnt} Reception antenna
Tx#1 to Tx#N_{TxAnt} Transmission antenna

What is claimed is:

1. A test system comprising:
an actual propagation path estimation characteristic calculation unit that calculates estimation characteristics of propagation path characteristics of an actual propagation path by using a reference signal included in IQ data of downlink signals output from an antenna device that receives the downlink signals transmitted from a plurality of transmission antennas of a network-side transmission/reception device by one or more reception antennas in an environment of the actual propagation path;
an actual propagation path channel capacity calculation unit that calculates an actual propagation path channel capacity of the actual propagation path from the estimation characteristics;
a K factor calculation unit that calculates a K factor from the estimation characteristics;
a reception antenna correlation calculation unit that calculates a reception antenna correlation that is a correlation among the estimation characteristics from each transmission antenna to the one or more reception antennas;
a transmission antenna correlation calculation unit that calculates a transmission antenna correlation that is a correlation among the estimation characteristics from the plurality of transmission antennas to each reception antenna by a transmission antenna correlation matrix that includes a transmission antenna correlation coefficient as a parameter;
a simulation propagation path characteristic calculation unit that calculates simulation propagation path characteristics of a channel model based on the K factor, the transmission antenna correlation, and the reception antenna correlation;
a simulation channel capacity calculation unit that calculates a simulation channel capacity of the channel model from the simulation propagation path characteristics; and
a transmission antenna correlation coefficient estimation unit that estimates the transmission antenna correlation coefficient in which a difference between the actual propagation path channel capacity and the simulation channel capacity is smaller than a specified value,
wherein the transmission antenna correlation calculation unit calculates the transmission antenna correlation by substituting the transmission antenna correlation coefficient estimated by the transmission antenna correlation coefficient estimation unit into the transmission antenna correlation matrix.

2. The test system according to claim 1, further comprising:
a relative phase estimation unit that calculates estimation values of relative phases of lines of sight of the downlink signals from the plurality of transmission antennas to the reception antennas,
wherein the simulation propagation path characteristic calculation unit calculates the simulation propagation path characteristics consisting of a sum of a line-of-sight component including the estimation values of the relative phases of the lines of sight and a non-line-of-sight component not including the influence of the line-of-sight component that can be expressed by the estimation values of the relative phases of the lines of sight.

3. The test system according to claim 2,
wherein the reception antenna correlation calculation unit calculates the reception antenna correlation such that an influence of the line-of-sight component including the estimation values of the relative phases of the lines of sight is excluded.

4. The test system according to claim 3,
wherein the reception antenna correlation and the transmission antenna correlation are included in the non-line-of-sight component in the simulation propagation path characteristics.

5. A transmission antenna correlation estimation method comprising:
an actual propagation path estimation characteristic calculation step of calculating estimation characteristics of propagation path characteristics of an actual propagation path by using a reference signal included in IQ data of downlink signals output from an antenna device that receives the downlink signals transmitted from a plurality of transmission antennas of a network-side transmission/reception device by one or more reception antennas in an environment of the actual propagation path;
an actual propagation path channel capacity calculation step of calculating an actual propagation path channel capacity of the actual propagation path from the estimation characteristics;
a K factor calculation step of calculating a K factor from the estimation characteristics;
a reception antenna correlation calculation step of calculating a reception antenna correlation that is a correlation among the estimation characteristics from each transmission antenna to the one or more reception antennas;
a transmission antenna correlation calculation step of calculating a transmission antenna correlation that is a correlation among the estimation characteristics from the plurality of transmission antennas to each reception antenna by a transmission antenna correlation matrix that includes a transmission antenna correlation coefficient as a parameter;
a simulation propagation path characteristic calculation step of calculating simulation propagation path characteristics of a channel model based on the K factor, the transmission antenna correlation, and the reception antenna correlation;
a simulation channel capacity calculation step of calculating a simulation channel capacity of the channel model from the simulation propagation path characteristics; and
a transmission antenna correlation coefficient estimation step of estimating the transmission antenna correlation coefficient in which a difference between the actual propagation path channel capacity and the simulation channel capacity is smaller than a specified value,
wherein, in the transmission antenna correlation calculation step, the transmission antenna correlation is calculated by substituting the transmission antenna correlation coefficient estimated by the transmission antenna correlation coefficient estimation step into the transmission antenna correlation matrix.

6. The transmission antenna correlation estimation method according to claim 5, further comprising:
a relative phase estimation step of calculating estimation values of relative phases of lines of sight of the downlink signals from the plurality of transmission antennas to the reception antennas,
wherein, in the simulation propagation path characteristic calculation step, the simulation propagation path characteristics consisting of a sum of a line-of-sight component including the estimation values of the relative phases of the lines of sight and a non-line-of-sight component not including the influence of the line-of-sight component that can be expressed by the estimation values of the relative phases of the lines of sight are calculated.

7. The transmission antenna correlation estimation method according to claim 6,
wherein, in the reception antenna correlation calculation step, the reception antenna correlation is calculated such that an influence of the line-of-sight component including the estimation values of the relative phases of the lines of sight is excluded.
